(19) United States
(12) Patent Application Publication
(10) Pub. No.: US 2017/0242882 A1
(43) Pub. Date: Aug. 24, 2017

(54) AN OVERLAY STREAM OF OBJECTS

(71) Applicant: HEWLETT PACKARD ENTERPRISE DEVELOPMENT LP, Houston, TX (US)

(72) Inventors: Mark Robert WATKINS, Stoke Gifford Bristol Avon (GB); Radoslaw RYCKOWSKI, Histon Cambridgeshire (GB); Muthukumar MURUGAN, Boulder, CO (US)

(73) Assignee: HEWLETT PACKARD ENTERPRISE DEVELOPMENT LP, Houston, TX (US)

(21) Appl. No.: 15/500,030

(22) PCT Filed: Sep. 30, 2014
(86) PCT No.: PCT/US2014/058286

§ 371 Date: Jan. 28, 2017

(51) Int. Cl. G06F 17/30

(52) U.S. Cl. CPC G06F 17/30345; G06F 17/30516

(57) ABSTRACT

To update a base stream of objects, an overlay stream of objects that update at least some respective objects in the base stream is created, where the overlay stream includes a reference to the base stream.

### BACKGROUND

A storage system can store data as objects. In some cases, the objects can be stored in a key-value store. A key-value store allows for objects to be stored according to a unique key that identifies the object. The value that corresponds to the key includes the object that is being stored.

### BRIEF DESCRIPTION OF THE DRAWINGS

Some implementations are described with respect to the following figures.

FIG. 1 is a schematic diagram of an example base stream of chunks that can be updated using techniques according to some implementations.

FIG. 2 is a schematic diagram illustrating an example base stream of chunks and an example overlay stream of chunks created in response to update of chunks in the base stream, in accordance with some implementations.

FIG. 3 is a schematic diagram illustrating an example base stream of chunks and another example overlay stream of chunks created in response to update of chunks in the base stream, in accordance with some implementations.

FIG. 4 is a flow diagram of an update process according to some implementations.

FIG. 5 is a flow diagram of a retrieve process according to some implementations.

FIG. 6 is a flow diagram of a delete process according to some implementations.

FIG. 7 is a block diagram of an example system according to some implementations.

### DETAILED DESCRIPTION

Objects stored in an object storage system may be unstructured, unlike files of a file system storage system that organizes data as files in a directory hierarchy. Objects can be stored in containers or other structures in a flat organization, and unique identifiers are associated with the objects. The unique identifiers (also referred to as “keys”) can be used to access (e.g. read or write) the objects. In some examples, an object storage system can store objects in a key-value store, where a key uniquely identifies each object, and a value represents the object.

Although reference is made to applying techniques or mechanisms according to some implementations to objects in an object storage system, it is noted that techniques or mechanisms according to further implementations can also be applied to other types of storage systems that store data. Thus, as used in this disclosure, an “object” can refer to any unit of data that can be stored in a storage system, where the unit of data can be part of objects in a flat organization, part of files in a directory hierarchy, or in any other type of organization.

A large object can be divided into smaller objects for storage in the object storage system. In some examples, the smaller objects can be referred to as chunks. As used here, a “large object” can refer to any object that can be divided into smaller objects.

In some examples, when a large object is modified, a new version of the entire large object may have to be created, in which case multiple versions of the large object are stored in the storage system. Providing multiple versions of a large object may be inefficient, since storage of the multiple versions of the large object consumes storage capacity, and communicating the multiple versions of a large object between systems consumes network bandwidth.

In other examples, modification of a large object can cause the older portions of the large object to be replaced with respective new portions, such that the older portions are not retained. In this case, versioning of large objects is not supported. As a result, a user, application, or another entity would not be able to retrieve a previous version of a large object that has been modified.

In accordance with some implementations, a large object can be represented as a stream of objects (e.g. chunks), where the chunks are produced by segmenting or otherwise dividing the large object into the chunks. In some examples, each chunk in the stream of chunks that represents a large object can have a fixed size. In other examples, chunks may be variably sized. Also, chunks in a first stream of chunks (that represents a first large object) can have a first size, whereas chunks in a second stream of chunks (that represents a second large object) can have a second, different size.

In the ensuing discussion, reference is made to a stream of chunks that corresponds to a large object. It is noted that a reference to “chunks” can also be a reference to objects in general that can be included in a stream of objects.

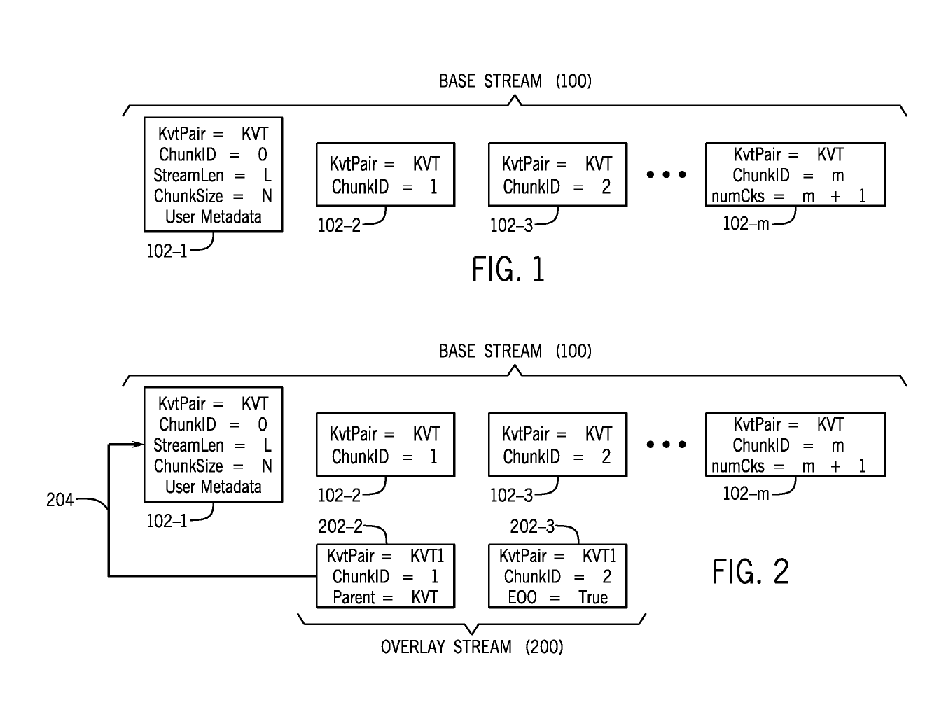

FIG. 1 shows an example stream 100 (referred to as a “base stream”) of chunks 102-1, 102-2, 102-3, . . . , 102-m. The chunks in the base stream 100 are chunks divided from a large object. As shown in FIG. 1, the base stream 100 of chunks includes a parent chunk (102-1), followed in sequence by other chunks. The parent chunk 102-1 can be the first chunk in the base stream 100. In other examples, the parent chunk of a base stream can be located elsewhere in the base stream.

The parent chunk 102-1 includes various metadata about the large object represented by the base stream 100 and about other chunks in the base stream 100. The metadata included in the parent chunk 102-1 can include a stream length (StreamLen), which is set equal to L. The stream length, L, specifies a length of the data represented by chunks 102-2, 102-3, . . . , 102-m following the parent chunk 102-1. In some examples, the stream length, L, can specify a number of bytes of the data included in the chunks 102-2, 102-3, . . . , 102-m. In other examples, the stream length, L, can indicate the size of the data included in the chunks 102-2, 102-3, . . . , 102-m using a different unit.

The metadata included in the parent chunk 102-1 can also include a chunk size (ChunkSize), which is set equal to N. The chunk size, N, specifies the size (e.g. number of bytes, etc.) of each of the chunks in the base stream 100. The metadata included in the parent chunk 102-1 can further include user-provided metadata (UserMetadata), which can be any metadata supplied by a user, an application, or any other entity.

Although specific examples of metadata are referred to above, it is noted that in other examples, other or additional metadata can be included in the parent chunk 102-1.

In accordance with some implementations, each chunk in the base stream 100 is assigned a chunk identifier (ChunkID). The ChunkID of the parent chunk 102-1 is set equal to an initial value, e.g. 0. In other examples, the ChunkID of the parent chunk 102-1 can be set to a different initial value.

The remaining chunks of the stream 100 have chunk identifiers that monotonically increase with each successive chunk. For example, the second chunk 102-2 (the chunk that follows the parent chunk 102-1) has a chunk identifier incremented by 1, such that the second chunk 102-2 has ChunkID=1. The third chunk 102-3 has ChunkID=2, and the last chunk 102-m has ChunkID=m. More generally, the chunk identifiers of the stream 100 monotonically advance (increase or decrease by some specified amount) with successive chunks in the base stream 100.

The large object represented by the base stream 100 can be uniquely identified by the following identifier (referred to as key-value pair identifier or KvtPair): value of a key and time value (represented by “KVT” in FIG. 1). The time value can be based on a time at which the large object was created. Each chunk within the base stream is uniquely identified by the combination of the key, time, and ChunkID.

The time value allows for versioning to be performed, since a new version of a large object (modified from a previous version of the large object) is associated with a new timestamp value (the new version of the large object is created at a later time than the previous version of the large object).

In some examples, the last chunk (102-m) in the base stream 100 can include an end-of-stream marker, represented as numCks. In the example of FIG. 1, numCks is set equal to m+1, since the number of chunks in the stream 100 is m+1. More generally, an end-of-stream marker can include another type of marker. In the base stream 100, a beginning-of-stream marker is provided by ChunkID=0, and the end-of-stream marker is indicated by numCks equal to a non-zero value.

In response to a request to update one or multiple chunks of the base stream 100, new version(s) of the updated chunk(s) is (are) created. In examples according to FIG. 2, it is assumed that the request to update causes an update of two chunks, e.g. chunks 102-2 and 102-3 in FIG. 1. A request to update can modify an existing chunk, insert a new chunk, or delete an existing chunk.

In response to the request to update, another stream of chunks 200 is created, as shown in FIG. 2. The new stream of chunks 200 can be referred to as an overlay stream of chunks. An overlay stream of chunks can refer to a stream of chunks that supplements a base stream of chunks. Note that an overlay stream can include just one chunk, or multiple chunks, depending on how many chunk(s) of the base stream is (are) modified by a request to update. The overlay stream of chunk(s) includes just updated data, and not data that has not been updated by the request to update. This allows for storage space conservation and reduced network bandwidth consumption when an overlay stream is communicated over a network.

In the example of FIG. 2, since just chunks 102-2 and 102-3 are updated, the overlay stream 200 of chunks includes the new versions of the chunks with ChunkID=1 and ChunkID=2. The new versions of each chunk are represented as 202-2 and 202-3 in FIG. 2, and share the same respective ChunkIDs as the chunks 102-2 and 102-3.

The key-value pair identifier (KvtPair) for the chunks in the overlay stream 200 differs from the key-value pair identifier of the chunks in the base stream 100. The key-value pair identifier for the overlay stream 200 is KVT1 instead of KVT, where T1>T and represents the timestamp at which chunks 202-2 and 202-3 were created due to the update of the chunks 102-2 and 102-3 in the base stream 100.

The first chunk in the overlay stream 200 (which is 202-2 in the example of FIG. 2) includes a reference 204 to the base stream 100. This reference 204 can identify the base stream 100 using the following information, for example: Parent=KVT (more specifically, a key-value identifier of the base stream 100). The last chunk in the overlay stream 200 includes an end-of-overlay marker, which is in the form of EOO=True in the example according to FIG. 2. In other examples, other example end-of-overlay markers can be used. Note that an overlay stream can start with any arbitrary ChunkID, based on which chunk of the base stream 100 is first in the sequence of the base stream 100 to be modified.

The reference included in the first chunk 202-2 of the overlay stream 200 can also be considered a pointer to the parent chunk (ChunkID=0) of the base stream 100.

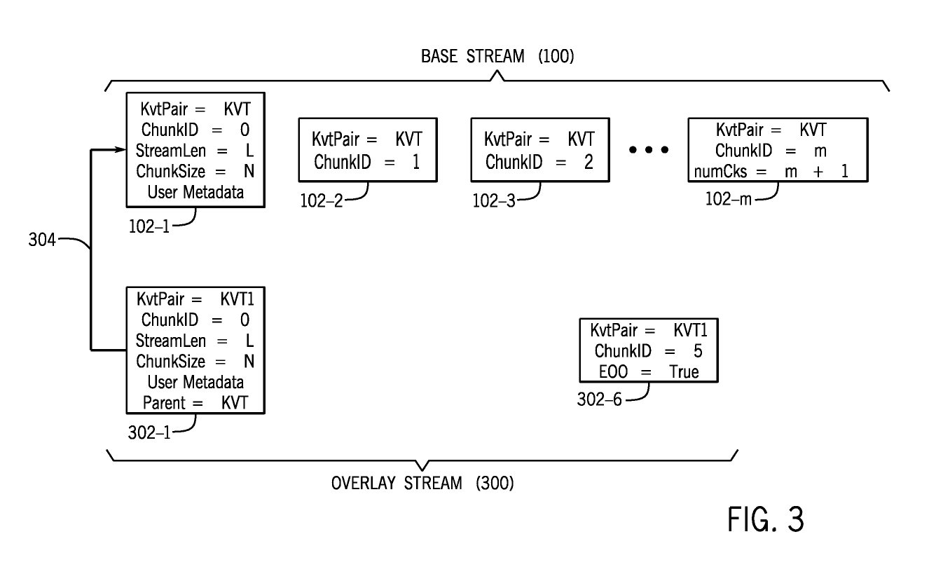

In the example of FIG. 2, it is assumed that the parent chunk 102-1 of the base stream has not been updated by the request to update. In other examples, the parent chunk 102-1 in the base stream 100 can be updated, in which case an overlay stream (e.g. 300 in FIG. 3) can include a modified version of the parent chunk 102-1. The modified version of the parent chunk 102-1 is represented as 302-1 in FIG. 3. The parent chunk 302-1 in the overlay stream 300 can include similar metadata as the parent chunk 102-1 in the base stream 100. The parent chunk 302-1 further includes a reference 304, represented by Parent=KVT in the example of FIG. 3, to the base stream 100.

Although FIG. 2 or 3 depicts just one update of the base stream 100, it is noted that the base stream 100 can be updated multiple times, in which case multiple respective overlay streams are created and associated with the base stream 100 (based on references from the overlay streams to the base stream 100).

In accordance with some implementations, by employing references (e.g. 204 or 304) from overlay streams to a base stream, as discussed above, a separate manifest does not have to be maintained for a different version of a large object. Thus, different versions of a large object can be provided (stored, created, etc.) without producing respective manifests. A manifest can include pointers to chunks that make up a specific version of the large object. If multiple versions of the large object exist, then multiple manifests are created. Creating and maintaining manifests can be associated with increased processing and storage burden in a storage system.

Also, maintaining different versions of a large object using overlay streams as discussed above can be more efficient than taking snapshots of different versions of data. Snapshots are computationally less efficient. A snapshot has to be explicitly created by an application every time there is an update to a base object. Creating a snapshot every time an update request is received may not be straightforward. Besides, when a snapshot is deleted, some blocks in the snapshot still remain in the storage system since other (later) snapshots may still be dependent on them.

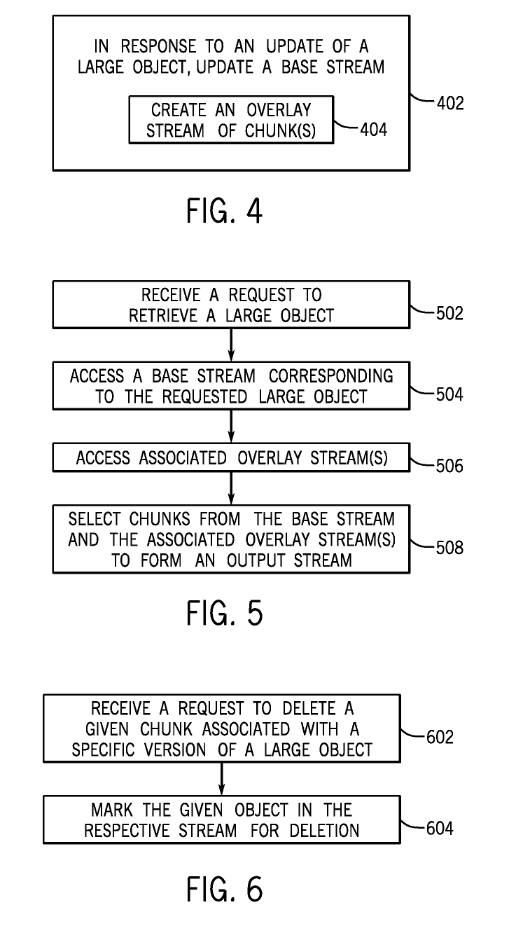

FIG. 4 is a flow diagram of a process of updating a large object, in accordance with some examples. In response to an update of a large object, the process of FIG. 4 updates (at 402) a base stream of objects (e.g., 100 in FIG. 1). As shown in FIG. 4, the updating includes creating (at 404) an overlay stream of chunk(s) (e.g. 200 in FIG. 2 or 300 in FIG. 3) that update(s) respective chunk(s) in the base stream 100. The created overlay stream also includes a reference (e.g. 204 or 304) to the base stream. The creation of the overlay stream of chunks does not have to be requested by an application; rather, the logic of a storage system can manage the creation of the overlay stream.

FIG. 5 is a flow diagram of a process of retrieving a large object in accordance with some implementations. The process of FIG. 5 receives (at 502) a request to retrieve a large object. In some examples, the request to retrieve can specify a specific version of the large object (e.g. latest version or version with time stamp Tx). In the absence of a specific version indicated in the request to retrieve, it can be assumed that the request is for the latest version.

The process of FIG. 5 then accesses (at 504) a base stream corresponding to the requested large object. If the request to retrieve is a request for a version later than an initial (earliest) version of the large object, then the process of FIG. 5 also accesses (at 506) overlay stream(s) associated with the accessed base stream. An overlay stream is associated with the accessed base stream if the overlay stream includes a reference to the accessed base stream. Note that if the request to retrieve is a request for a version not later than an initial version of the large object, then the process of FIG. 5 does not access any overlay streams.

The process of FIG. 5 then selects (at 508) chunks from the base stream 100 and the associated overlay stream(s) to form an output stream of chunks in response to the request to retrieve. For example, in FIG. 2, if the request to retrieve is a request for the latest version, then the chunks selected for the output stream are as follows: chunk 102-1, chunk 202-2, chunk 202-3, . . . , 102-m.

More generally, depending on the version requested, the process of FIG. 5 retrieves the latest version of each chunk (in the base stream) up to the requested version. In other words, if a chunk with ChunkID=0 has been updates several times such that there is a base version (in the base stream identified by KVT), a first version (in a first overlay stream identified by KVT1), and a second version (in a second overlay steam identified by KVT2), and the request to retrieve is for version T1, then the latest version of the chunk with ChunkID=0 that is retrieved is the first version in the first overlay stream identified by KVT1 (even though a later version in the overlay stream identified by KVT2 exists).

FIG. 6 is a flow diagram of a process for deleting a chunk. The process of FIG. 6 receives (at 602) a request to delete a given chunk associated with a specific version of a large object. The request to delete can specify that the given chunk of the latest version be deleted. Alternatively, the request to delete can specify a specific version to delete (e.g. version T1, version T, etc.).

In response to the request to delete, the process of FIG. 6 marks (at 604) the given object (of the specified version) in the respective stream (a base stream or an overlay stream) for deletion. Note that at this point, the given object of the specified version is not yet physically removed from the storage system.

A background scrubber process (also referred to as a garbage collector) can be run (continuously or intermittently or periodically) to process objects (e.g. chunks) in the object storage system. The scrubber process can identify objects (e.g. chunks) that have been marked for deletion. The process can then remove the objects that have been marked for deletion.

By using techniques or mechanisms according to some implementations, multiple versions of an object can be maintained more efficiently. An update of a large object can involve just the storing and upload of parts of a base stream of chunks that have been changed. Also, any arbitrary version of the large object can be easily retrieved. As a result of employing the base and overlay streams to maintain different versions of large objects, the functionality of a storage system (which is implemented as one or multiple computer systems) can be improved, by rendering the storage system more efficient and more responsive to requests to access data. Also, techniques or mechanisms according to some implementations improve a specific technical field, namely the field of storage systems.

Examples of use cases can include any of the following, for example. A large object can include multimedia data including video, audio, and other data. Annotations can be added to certain portions of the multimedia data, where the annotated portions can be represented as chunks in overlay streams.

In another example, multiple versions of a virtual machine (which is executed in a physical machine) can be maintained. In yet another example, selected pages of an electronic book that have been updated can be stored as chunks in overlay streams. There can be other applications of techniques or mechanisms according to some implementations.

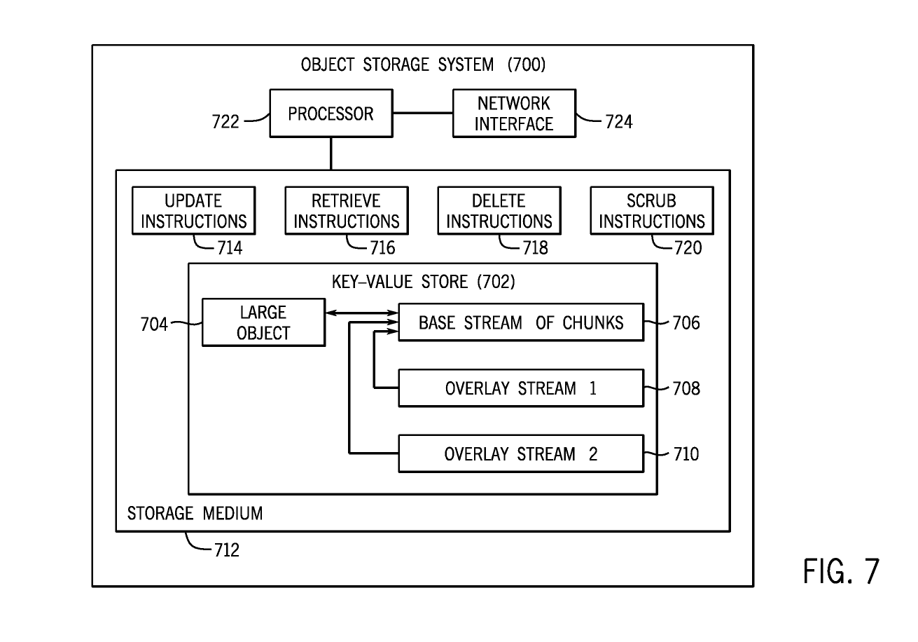

FIG. 7 is a block diagram of an object storage system according to some implementations. The object storage system 700 includes a key value store 702 that stores a large object 704 as a base stream 706 of chunks. One or multiple overlay streams 708, 710 of chunks can be associated with the base stream 706 of chunks, where each overlay stream of chunks contains those chunks that have been updated from the base stream 706 of chunks.

The key-value store 702 can be stored in a non-transitory machine-readable or computer-readable storage medium (or storage media) 712. In addition, the storage medium (or storage media) 712 can store various machine-readable or machine-executable instructions, such as update instructions 714 for updating a large object (such as according to FIG. 4), retrieve instructions 716 for retrieving a requested version of a large object (such as according to FIG. 5), delete instructions 718 for deleting one or multiple chunks in a base stream or an overlay stream (such as according to FIG. 6), and scrubber instructions 720 to scrub (remove) chunks that have been marked for deletion.

The instruction 714, 716, 718, and 720 can be executed by one or multiple processors 722 of the object storage system 700. A processor can include a microprocessor, microcontroller, a physical processor module or subsystem, programmable integrated circuit, programmable gate array, or another control or computing device. The object storage system 700 can also include a network interface 724 to allow the object storage system 700 to communicate with other nodes over a network.

The storage medium (or storage media) 712 can include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
updating, in a system including a processor, a base stream of objects, the updating comprising creating an overlay stream of objects that update at least some respective objects in the base stream, the overlay stream including a reference to the base stream.

2. The method of claim 1, further comprising:
including the reference in one of the objects in the overlay stream.

3. The method of claim 2, wherein the reference includes a key-value identifier of the base stream.

4. The method of claim 3, wherein the key-value identifier includes a value of a key and a timestamp.

5. The method of claim 1, further comprising:
monotonically advancing identifier values of the objects in the base stream successively from a first object in the base stream to a last object in the base stream.

6. The method of claim 5, further comprising:
including an end-of-stream marker with the last object in the base stream.

7. The method of claim 6, further comprising:
including an end-of-stream marker with a last object in the overlay stream.

8. The method of claim 1, further comprising:
in response to a request to delete a given object associated with a specific version, marking the given object in one of the base stream and the overlay stream for deletion.

9. The method of claim 8, further comprising:
identifying, by a background scrubber process in the system, at least one object in the base stream and the overlay stream that has been marked for deletion; and
removing, by the background scrubber process, the identified at least one object marked for deletion.

10. A storage system comprising:
at least one machine-readable storage medium; and
at least one processor to:
store a base stream of objects corresponding to a large object in the at least one machine-readable storage medium;
store an overlay stream of objects that includes a reference to the base stream of objects, wherein the objects of the overlay stream are modified from respective objects in the base stream, and wherein the overlay stream includes a subset of objects less than the objects of the base stream.

11. The storage system of claim 10, wherein the at least one processor is to further create the overlay stream of objects in response to a request to update the base stream of objects.

12. The storage system of claim 10, wherein the at least one processor is to further:
receive a request to retrieve a version of a plurality of versions of the large object; and
select objects from the base stream and overlay stream to form an output stream of objects in response to the request to retrieve.

13. The storage system of claim 10, wherein the objects in the base stream include identifiers that monotonically advance successively from a first object in the base stream to a last object in the base stream, and wherein the objects in the overlay stream include same identifiers as respective objects in the base stream.

14. An article comprising at least one machine-readable storage medium storing instructions that upon execution cause a storage system to:
store a base stream of chunks, the base stream corresponding to content of an object;
receive a request to update the object; and
in response to the request to update, create an overlay stream of chunks that includes a reference to the base stream of chunks, wherein the chunks of the overlay stream are modified versions of respective chunks of the base stream.

15. The article of claim 14, wherein the instructions upon execution cause the storage system to further:
receive a request to retrieve a specified version of the object; and
use the chunks of the base stream and the chunks of the overlay stream to produce an output in response to the request to retrieve.
